(19) United States
(12) Patent Application Publication
(10) Pub. No.: US 2025/0285411 A1
(43) Pub. Date: Sep. 11, 2025

(54) LEARNING DEVICE AND LEARNING METHOD

(71) Applicants: NEC Corporation, Tokyo (JP); Tokyo University of Science Foundation, Tokyo (JP)

(72) Inventors: Takashi SHIBATA, Tokyo (JP); Go Irie, Tokyo (JP)

(73) Assignees: NEC Corporation, Tokyo (JP); Tokyo University of Science Foundation, Tokyo (JP)

(21) Appl. No.: 19/063,510

(22) Filed: Feb. 26, 2025

(30) Foreign Application Priority Data
Mar. 7, 2024 (JP) 2024-034612

(51) Int. Cl. G06V 10/74

(52) U.S. Cl. CPC G06V 10/761

(57) ABSTRACT

A learning device receives input of first data and second data and divides a plurality of elements of parameters of the second data, which are input to a model that estimates a correlation between the first data and the second data, into a plurality of partial parameter elements, and performs training, for each of the partial parameters or each of combinations of the partial parameters, by using a value of an element included in the partial parameter or the combination of the partial parameters based on an estimation result obtained by inputting the first data and the second data into the model.

### CROSS-REFERENCE TO RELATED APPLICATIONS

This application is based upon and claims the benefit of priority from Japanese patent application No. 2024-034612, filed on Mar. 7, 2024, the disclosure of which is incorporated herein in its entirety by reference.

### TECHNICAL FIELD

The present disclosure relates to a learning device and a learning method.

### BACKGROUND ART

A prompt may be input to a learned model, and the prompt may be adjusted to improve the accuracy of the model's output (see, for example, Japanese Unexamined Patent Application, Publication No. 2023-071912).

There may be cases where input data to a model is learned without being able to obtain a differentiable function that shows the relationship between the input data to the model and the output data of the model, such as in a case where learning prompts to be input to a model used as a black box. In this case, it is preferable to improve the efficiency of learning.

### SUMMARY

An example of an objective of the present disclosure is to provide a learning device and a learning method that can solve the above-mentioned problems.

According to the first example aspect of the present disclosure, a learning device is provided with a learning parameter decomposition means that receives input of first data and second data and divides a plurality of elements of parameters of the second data, which are input to a model that estimates a correlation between the first data and the second data, into a plurality of partial parameter elements; and a learning means that learns, for each of the partial parameters or each of combinations of the partial parameters, a value of an element included in the partial parameter or the combination of the partial parameters based on an estimation result obtained by inputting the first data and the second data into the model.

According to the second example aspect of the present disclosure, a learning device is provided with a learning parameter decomposition means that divides a plurality of elements of parameters of input data to be input to a learned model into a plurality of partial parameter elements; and a learning means that learns, for each of the partial parameters or each of combinations of the partial parameters, a value of an element included in the partial parameter or the combination of the partial parameters based on a model output value obtained by inputting the input data into the model.

According to the third example aspect of the present disclosure, an estimation system is provided with a model that receives input of first data and second data and estimates a correlation between the first data and the second data; a learning parameter decomposition means that divides a plurality of elements of the parameters of the second data into a plurality of partial parameter elements; and a learning means that learns, for each of the partial parameters or each of combinations of the partial parameters, a value of an element included in the partial parameter or the combination of the partial parameters based on an estimation result obtained by inputting the first data and the second data into the model.

According to the fourth example aspect of the present disclosure, a learning method includes a computer: receiving input of first data and second data and dividing a plurality of elements of parameters of the second data, which are input to a model that estimates a correlation between the first data and the second data, into a plurality of partial parameter elements; and learning, for each of the partial parameters or each combination of the partial parameters, a value of an element included in the partial parameter or the combination of the partial parameters based on an estimation result obtained by inputting the first data and the second data into the model.

According to the fifth example aspect of the present disclosure, a program is one that causes a computer to execute receiving input of first data and second data and dividing a plurality of elements of parameters of the second data, which are input to a model that estimates a correlation between the first data and the second data, into a plurality of partial parameter elements; and learning, for each of the partial parameters or each combination of the partial parameters, a value of an element included in the partial parameter or the combination of the partial parameters based on an estimation result obtained by inputting the first data and the second data into the model.

### BRIEF DESCRIPTION OF THE DRAWINGS

FIG. 1 is a diagram illustrating an example of a configuration of an estimation system according to at least one example embodiment.

FIG. 2 is a diagram showing an example of a configuration of a learning device according to at least one example embodiment.

FIG. 3 is a diagram illustrating an example of data input/output at each part of a processing portion according to at least one example embodiment.

FIG. 4 is a diagram illustrating an example of a data structure of a prompt acquired by a prompt acquisition portion according to at least one example embodiment.

FIG. 5 is a diagram illustrating an example of a learning parameter decomposition portion according to at least one example embodiment dividing a learning parameter into partial parameters.

FIG. 6 illustrates an example of how a learning parameter decomposition portion according to at least one example embodiment divides learning parameters into common parameters and individual parameters.

FIG. 7 is a diagram illustrating an example of a process by which a learning device according to at least one example embodiment learns a prompt.

FIG. 8 is a diagram illustrating another example of a configuration of a learning device according to at least one example embodiment.

FIG. 9 is a diagram illustrating yet another example of a configuration of a learning device according to at least one example embodiment.

FIG. 10 is a diagram illustrating another example configuration of an estimation system according to at least one example embodiment.

FIG. 11 is a diagram illustrating an example of a processing procedure in a learning method according to at least one example embodiment.

FIG. 12 is a diagram illustrating an example configuration of a computer in accordance with at least one example embodiment.

### EXAMPLE EMBODIMENT

Hereinbelow, example embodiments of the present disclosure will be described, but the disclosure according to the claims is not limited to the following example embodiments. Furthermore, not all of the combinations of features described in the example embodiments are necessarily essential to the solutions of the disclosure.

In the following, a character with a circumflex may be indicated by adding a “\hat{ }” after the character. For example, a z with a circumflex would be written as z\hat{ }.

### First Example Embodiment

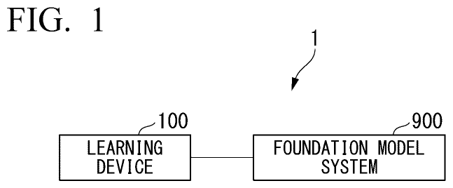

FIG. 1 is a diagram illustrating an example of a configuration of an estimation system according to at least one example embodiment. In the configuration shown in FIG. 1, an estimation system 1 is provided with a learning device 100 and a foundation model system 900.

The foundation model system 900 receives input of first data and second data as input, and estimates a correlation between the input first data and second data.

In the following, an example will be described in which the first data is image data, the second data is a prompt, and the foundation model system 900 identifies the image input as the first data (classifies the image).

In this case, the prompt is data input to the foundation model system 900 other than the image data that is directly targeted for identification. The prompt may be any data that can be input into the foundation model system 900 and is not limited to any particular type of data. For example, a prompt may be constructed that includes a combination of a real vector and a string of characters.

However, the processing performed by the foundation model system 900 is not limited to image identification, and can be various image recognition processes. For example, the foundation model system 900 may perform object detection to detect the position where an object appears in an image, or area detection to detect the area where an object appears in an image.

In addition, in a case where the foundation model system 900 identifies an image, it may perform object classification to identify the type of object appearing in the image, or it may perform scene recognition to recognize the scene appearing in the image.

Furthermore, the input data to the foundation model system 900 is not limited to a specific type of data, and the number of input data is not limited to a specific number. The input data to the foundation model system 900 can be various data including the parameters to be learned.

For example, the input data to the foundation model system 900 may include data other than image data, such as voice data or sensor measurement data, as data to be recognized.

Furthermore, the input data to the foundation model system 900 may be configured as a single piece of data, such as data in which the data to be recognized and the prompt are not distinguished.

In addition, in cases where the foundation model system 900 is a system that generates images or text, for example, the input data to the foundation model system 900 may be configured as a single piece of data consisting of a prompt to instruct the foundation model system 900 to perform processing.

The learning device 100 learns the prompt input to the foundation model system 900. The learning device 100 learns the prompt so as to improve the image identification accuracy (classification accuracy) of the foundation model system 900.

The learning device 100 is configured using, for example, a computer.

In the following, an example will be described in which the foundation model system 900 is treated as a black box. In particular, the learning device 100 is unaware of the internal structure of the foundation model system 900, and is therefore unable to use the gradient method (a solution search method that uses gradient information obtained by differentiating a model function) to learn the prompt. For example, it is assumed that the learning device 100 is unable to obtain a differentiable function that indicates the relationship between input values (input data) to the foundation model system 900.

As for the learning of the foundation model system 900 (adjustment of the internal parameter values of the foundation model system 900) itself, the learning device 100 may or may not be able to learn the foundation model system 900. Even if the learning device 100 is unable to learn the foundation model system 900, it is possible to improve the accuracy of the estimation results obtained from the foundation model system 900 by generating prompts suitable for the foundation model system 900 through prompt learning.

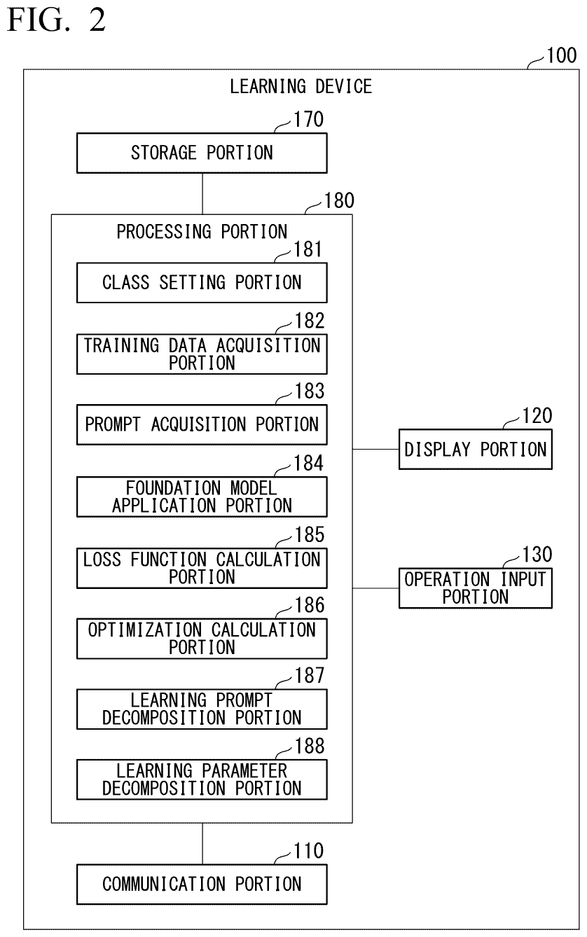

FIG. 2 is a diagram illustrating an example of the configuration of the learning device 100. In the configuration of FIG. 2, the learning device 100 is provided with a communication portion 110, a display portion 120, an operation input portion 130, a storage portion 170, and a processing portion 180. The processing portion 180 is provided with a class setting portion 181, a training data acquisition portion 182, a prompt acquisition portion 183, a foundation model application portion 184, a loss function calculation portion 185, an optimization calculation portion 186, a learning prompt decomposition portion 187, and a learning parameter decomposition portion 188.

The communication portion 110 communicates with other devices. For example, the communication portion 110 transmits image data and a prompt to the foundation model system 900. In addition, the communication portion 110 receives estimation results from the foundation model system 900.

The display portion 120 has a display screen, such as a liquid crystal panel or a Light Emitting Diode (LED) panel, and acquires various images. For example, the display portion 120 may display an input image to the foundation model system 900 and an estimation result by the foundation model system 900.

The operation input portion 130 includes input devices such as a keyboard and a mouse, and receives user operations. For example, the operation input portion 130 may receive a user operation for inputting a class for image classification (classification).

The storage portion 170 stores various types of data. For example, the storage portion 170 stores prompts to be learned and training data for learning the prompts.

The storage portion 170 is configured using a storage device provided in the learning device 100.

The processing portion 180 controls each unit of the learning device 100 to perform various processes. The functions of the processing portion 180 are performed, for example, by a Central Processing Unit (CPU) included in the learning device 100 reading and executing a program from the storage portion 170.

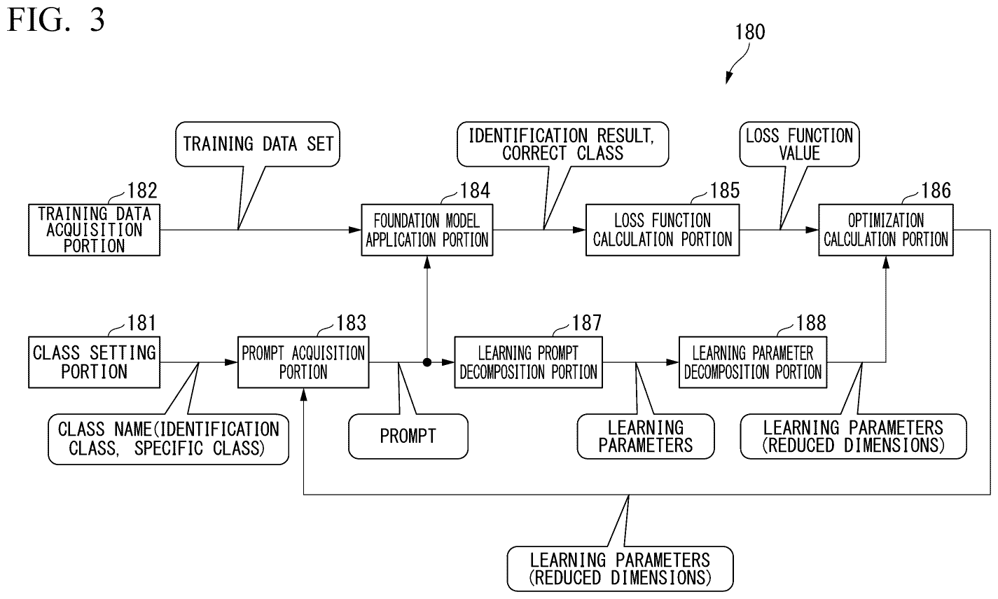

FIG. 3 is a diagram showing an example of data input/output in each portion of the processing portion 180.

The class setting portion 181 obtains a class name for image classification. The class setting portion 181 may obtain the class names of classes for which images are to be classified and the class names of classes for which images are not to be classified. The class in which an image is to be classified is also called an identification class. A class in which it is not desired to classify images is also called a specific class.

The acquisition of a class name by the class setting portion 181 can be considered as setting a class as a candidate for identifying an image.

The class names acquired by the class setting portion 181 may be nouns indicating candidates for classification targets, such as “dog” and “cat.” Alternatively, the class name acquired by the class setting portion 181 may include a modifier, such as “red dog” or “white cat,” or may be a sentence. The class setting portion 181 outputs the acquired class name to the prompt acquisition portion 183.

The training data acquisition portion 182 acquires a training data set for use in learning prompts by the learning device 100. The training data acquisition portion 182 acquires, as a training data set, a data set of training data consisting of pairs of image data and correct answer values for the class of the image. The training data acquisition portion 182 may acquire a data set that is publicly available as the training data set.

The training data acquisition portion 182 outputs the acquired training data set to the foundation model application portion 184.

The prompt acquisition portion 183 acquires a prompt. The prompt acquisition portion 183 corresponds to an example of a second data acquisition portion.

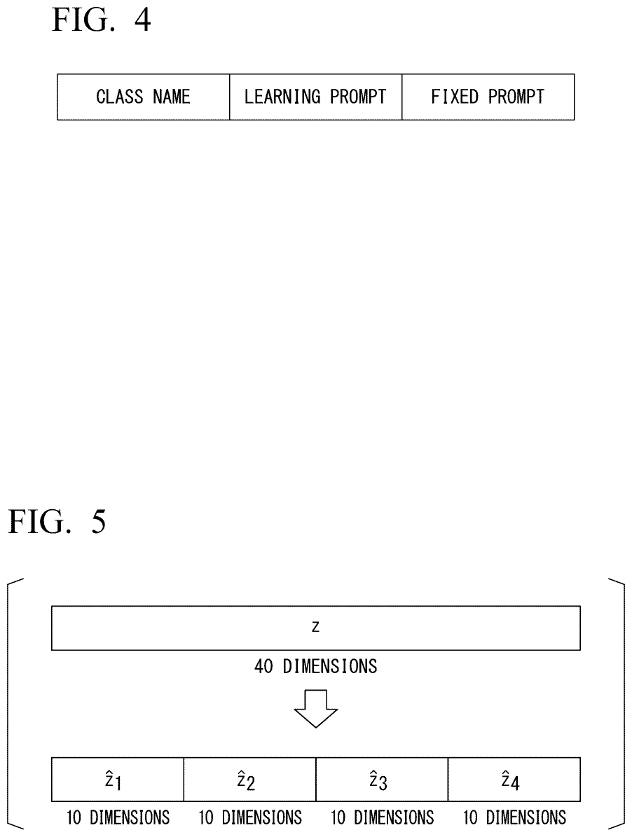

FIG. 4 is a diagram showing an example of the data structure of a prompt acquired by the prompt acquisition portion 183. In the example of FIG. 4, the prompt includes a class name, a learning prompt, and a fixed prompt.

The class name included in the prompt can be the class name acquired by the class setting portion 181. The prompt acquisition portion 183 may include a class name in the prompt so that the class name of the identification class can be distinguished from the class name of the specific class. For example, the prompt acquisition portion 183 may set the correct class name shown in the training data, among the class names pre-registered as class candidates, as the class name of the identification class, and include the other class names in the prompt as class names of specific classes.

The learning prompt is the portion of a prompt that is the subject of learning. That is, the learning prompt is data whose value is updated by learning the prompt. On the other hand, the class name portion of the prompt and the fixed prompt portion may be fixed data (data whose values are not subject to updating through learning).

The learning prompt may be constituted in the form of a real vector having multiple elements.

The prompt acquisition portion 183 may use a learning prompt generated from random learning parameter values as the initial value of the learning prompt.

Furthermore, as described below, in a case where the optimization calculation portion 186 performs an optimization calculation, the prompt acquisition portion 183 generates a learning prompt by using the parameter values updated by the optimization calculation.

The fixed prompt is a portion of the prompt whose value is determined in advance. For example, a fixed prompt may be configured as text data including a specific phrase, such as “a photo of <class name>.” “a photo of <class name>” is an example of a fixed prompt that allows the foundation model system 900 to estimate what the input image data depicts. The foundation model system 900 estimates the class name to be inserted in the “<class name>” portion.

In a case where few-shot learning can be performed on the foundation model system 900, in the few-shot learning, the prompt acquisition portion 183 inserts the correct class name into the “<class name>” portion.

The prompt acquisition portion 183 generates a prompt by combining the class name, the learning prompt, and the fixed prompt. For example, the prompt acquisition portion 183 combines the class name, the learning prompt, and the fixed prompt in that order. That is, the prompt acquisition portion 183 generates a prompt in which the class name, the learning prompt, and the fixed prompt are arranged in this order.

The prompt acquisition portion 183 outputs the generated prompt to the foundation model application portion 184 and the learning prompt decomposition portion 187.

The foundation model application portion 184 inputs data to the foundation model system 900 and obtains the estimation result output by the foundation model system 900.

Specifically, the foundation model application portion 184 controls the communication portion 110 to transmit image data (one image data piece from the training data set) from the training data acquired by the training data acquisition portion 182 and the prompt acquired by the prompt acquisition portion 183 to the foundation model system 900.

In addition, the following describes an example in which the foundation model application portion 184 receives a likelihood vector indicating the likelihood (reliability) of each class name shown in the prompt from the foundation model system 900 via the communication portion 110 as an estimation result by the foundation model system 900.

The foundation model application portion 184 outputs the obtained estimation result and the class name of the correct class (the class name in the training data that includes the image data input to the foundation model system 900) to the loss function calculation portion 185.

The loss function calculation portion 185 calculates a loss function value for learning the prompt based on the estimation result obtained by the foundation model application portion 184. The loss function calculation portion 185 outputs the calculated loss function value to the optimization calculation portion 186.

The loss function used here is one that indicates a larger value (i.e., a worse evaluation) as the correlation value between the image and the identification class and the correlation value between the image and the specific class become more uniform. More specifically, a loss function that indicates a larger value (i.e., a worse evaluation) is used as the likelihood for a class other than the correct class increases in comparison with the likelihood for the correct class.

In addition, with regard to the identification class, a loss function is used that indicates a smaller value (i.e., a better evaluation) as the correlation value between the image and the class increases. More specifically, the greater the likelihood of the correct class, the smaller the loss function that is used (i.e., a better evaluation).

For example, the learning device 100 may use cross-entropy loss obtained from the correlation between the input image to the foundation model system 900 and each class indicated in the prompt as a loss function for learning the prompt.

However, the loss function used by the learning device 100 is not limited to a specific function. Furthermore, the learning device 100 may use an evaluation function in which a larger evaluation function value indicates a better evaluation.

The optimization calculation portion 186 uses the loss function value calculated by the loss function calculation portion 185 to perform optimization calculations on the parameter values of the learning prompt. Specifically, the optimization calculation portion 186 searches for parameter values that result in a smaller loss function value (i.e., a better evaluation).

In particular, the optimization calculation portion 186 performs optimization calculations of the parameter values of the learning prompt without using a differentiable function that indicates the relationship between the input data to the foundation model system 900 and the output data of the foundation model system 900.

For example, the optimization calculation portion 186 may perform the optimization calculation using a black-box optimization technique such as the Covariance Matrix Adaptation Evolution Strategy (CMA-ES). However, the method of the optimization calculation performed by the optimization calculation portion 186 is not limited to a specific method.

The optimization calculation portion 186 updates the learning parameter values obtained from the learning parameter decomposition portion 188 through optimization calculations. The optimization calculation performed by the optimization calculation portion 186 corresponds to an example of learning of a learning parameter value. The optimization calculation portion 186 corresponds to an example of a learning means.

The optimization calculation portion 186 does not perform optimization calculations on the entire learning parameters represented by vectors at once, but performs optimization calculations on learning parameters with reduced dimensions, which correspond to a portion of the learning parameters. The number of dimensions of the parameter referred to here is the number of dimensions in the vector expression of the parameter, that is, the number of elements of the parameter.

The optimization calculation portion 186 updates the values of the learning parameters whose dimensions have been reduced through optimization calculations. Then, the optimization calculation portion 186 outputs the updated values of the learning parameters with reduced dimensions to the prompt acquisition portion 183.

The learning prompt decomposition portion 187 linearly decomposes the elements of the learning prompt acquired by the prompt acquisition portion 183 into a projection matrix, a basis vector, and an average prompt. The learning prompt decomposition portion 187 corresponds to an example of a learning prompt decomposition means.

Here, a learning prompt p has m elements and is denoted as p=(p₁, p₂, . . . , pₘ). Here, m is an integer greater than or equal to 1 indicating the number of learnable contexts. The learnable context here refers to the number of elements in the prompt that are to be learned, such as the number of words in the prompt that are to be learned, or the number of real variable vectors to be learned that are included in the prompt.

As a conversion method in a case where the learning device 100 converts a prompt into a real vector, a known prompt embedding method may be used. However, the conversion method used by learning device 100 to convert a prompt into a real vector is not limited to a specific one.

Here, it is assumed that the elements pᵢ of the learning prompt are represented by a D-dimensional real vector such that pᵢ∈R^{D}. Here, i is an integer such that 1≤i≤m.

The element pᵢ of the learning prompt corresponds to an example of partial data of the second data that is represented by a real number vector.

D denotes the number of dimensions of the prompt space. That is, D indicates the number of dimensions of the embedding vector in a case where the prompt is converted into an embedding vector and quantified. Let D be an integer such that D≥2.

R^{D} denotes a D-dimensional real space (D-dimensional space, real D-space).

The decomposition of the learning prompt element pᵢ performed by the learning prompt decomposition portion 187 is expressed as in Equation (1).

$${p}_{i} = A {\hat{z}}_{i} + {p}_{o} \qquad ( 1 )$$

z\hat{ }ᵢ denotes the basis vector. Here, the basis vector z\hat{ }ᵢ is a d-dimensional real vector to be learned. Here, d is a natural number such that 1≤d<D, and is expressed as z\hat{ }ᵢ∈R^{d}.

A vector z=(z\hat{ }₁, z\hat{ }₂, . . . , z\hat{ }ₘ) obtained by concatenating basis vectors z\hat{ }₁, z\hat{ }₂, . . . , z\hat{ }m is used as a learning parameter (parameter of the learning prompt). Let the learning parameter z be the learning target in learning the prompt (the parameter whose parameter value is to be updated), and it is expressed as z∈R^{d×m}.

A vector consisting of one or more elements of the learning parameter z (a vector obtained by projecting the learning parameter z from the vector space to the partial vector space) is also called a partial parameter.

The basis vector z\hat{ }ᵢ is also called a partial parameter z\hat{ }ᵢ.

A denotes the projection matrix. Here, the projection matrix A is a matrix that projects the partial parameter z\hat{ }ᵢ onto a D-dimensional real vector. It is expressed as A∈R^{D×d}.

As the projection matrix A, a matrix of real constants may be used, with the elements randomly sampled from a normal distribution having the word embedding variance of the vocabulary assumed to be the vocabulary of the prompts received by the foundation model system 900. That is, for the projection matrix A, the distribution obtained by converting the vocabulary assumed to be the vocabulary of the prompts received by the foundation model system 900 into an embedding vector using a D-dimensional real vector is assumed to be a normal distribution. Then, elements of the projection matrix A may be randomly sampled from a normal distribution having the variance of the normal distribution and a mean value of 0.

p₀ indicates the average prompt. The average prompt p₀ is a real vector indicating the offset contained in element pᵢ of the training prompt. It is denoted as p₀∈R^{D}.

As the average prompt p₀, the average word embedding value of the vocabulary expected as the vocabulary of the prompts received by the foundation model system 900 may be used. That is, as described above, the distribution obtained by converting the vocabulary expected as the vocabulary of the prompts received by the foundation model system 900 into an embedding vector using a D-dimensional real vector as vector p₀ is assumed to be a normal distribution. Then, the mean value of the normal distribution may be used as vector p₀. In this case, the average prompt p₀ can be calculated from the training data set acquired by the training data acquisition portion 182.

The learning prompt decomposition portion 187 outputs the learning parameter z to the learning parameter decomposition portion 188.

The learning parameter decomposition portion 188 divides the learning parameter z into partial parameters, and sets the partial parameters or parameters formed by connecting the partial parameters as parameters to be learned in learning the prompt.

The learning parameter decomposition portion 188 corresponds to an example of a learning parameter decomposition means.

The concatenation of parameters here is performed by concatenating vectors. That is, in concatenating parameters, elements in the vector representation of a plurality of parameters are arranged in order to generate a parameter expressed as a single vector.

Moreover, the division of a parameter here means dividing a plurality of parameter elements into a plurality of parameter elements. Therefore, dividing the learning parameter z into partial parameters means dividing the multiple elements of the learning parameter z into multiple partial parameter elements.

Partial parameters obtained by dividing the learning parameter z, or parameters that have fewer dimensions than the original learning parameter and are generated by concatenating partial parameters, are also referred to as dimensionally reduced learning parameters.

FIG. 5 is a diagram showing an example in which the learning parameter decomposition portion 188 divides the learning parameter z into partial parameters.

In the example of FIG. 5, the learning parameter decomposition portion 188 divides the learning parameter z, which is configured as a 40-dimensional vector, into four partial parameters z\hat{ }₁, z\hat{ }₂, z\hat{ }₃, and z\hat{ }₄, which are 10-dimensional vectors.

However, the number of dimensions of the learning parameter z is not limited to a specific number of dimensions. Furthermore, the number and number of dimensions of partial parameters obtained by dividing the learning parameter z by the learning parameter decomposition portion 188 are not limited to a specific number and number of dimensions. Furthermore, the partial parameters z\hat{ }ᵢ obtained by the learning parameter decomposition portion 188 dividing the learning parameter z may be the same as the above-mentioned basis vectors z\hat{ }ᵢ, or may be different.

Furthermore, the method by which the learning parameter decomposition portion 188 selects which elements of the learning parameter z to combine into partial parameters is not limited to a specific selection method. For example, the learning parameter decomposition portion 188 may generate partial parameters z\hat{ }ᵢ by combining elements of the learning parameter z that are not adjacent to each other.

As described above, the optimization calculation portion 186 performs optimization calculations of the parameter values of the learning prompt without using a differentiable function that indicates the relationship between the input data to the foundation model system 900 and the output data from the foundation model system 900. In this case, the amount of calculations is greater than in a case where the gradient method is used because the differential value, which indicates the direction in which to increase or decrease the value of each element of the parameter of the learning target (the target for updating the parameter value) and the amount of change, is not used.

In particular, as the number of parameter elements increases, the number of combinations of the direction and amount of change of each element value increases, resulting in a combinatorial explosion of the amount of calculations.

Therefore, rather than subjecting all elements of the learning parameter z to optimization calculations at once, it is possible to divide the learning parameter z into partial parameters z\hat{ }ᵢ and perform solution search by optimization calculations for each partial parameter z\hat{ }ᵢ.

In the example of FIG. 5, in a case where the optimization calculation portion 186 performs optimization calculations using a 40-dimensional learning parameter z as the learning target, the size (number of dimensions) of the covariance matrix to be optimized is 40 dimensions by 40 dimensions. On the other hand, in a case where the optimization calculation portion 186 performs optimization calculations using each of the partial parameters z\hat{ }₁, z\hat{ }₂, z\hat{ }₃, and z\hat{ }₄ as learning objects, the size of the covariance matrix optimized in each optimization calculation is 10 dimensions by 10 dimensions.

On the other hand, in a case where the optimization calculation portion 186 performs optimization calculations for each partial parameter that is independent of each other, the accuracy of learning (the accuracy of the parameter value obtained by the optimization calculation) is likely to decrease compared to in a case where the optimization calculation portion 186 subjects all elements of the learning parameter z to optimization calculations at once.

Therefore, the learning parameter decomposition portion 188 may divide the learning parameter z into a common parameter and an individual parameter. Then, the optimization calculation portion 186 may perform optimization calculations for each combination of a common parameter and one individual parameter.

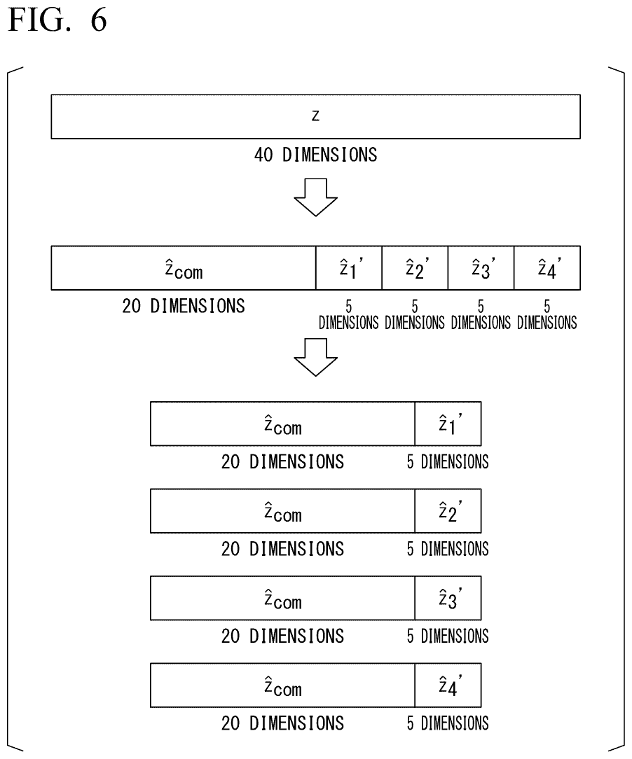

FIG. 6 is a diagram showing an example in which the learning parameter decomposition portion 188 divides the learning parameter z into a common parameter and an individual parameter.

In the example of FIG. 6, the learning parameter decomposition portion 188 divides the learning parameter z, which is configured as a 40-dimensional vector, into one common parameter z\hat{ }_{com}, which is a 20-dimensional vector, and four individual parameters z\hat{ }₁′, z\hat{ }₂′, z\hat{ }₃′, and z\hat{ }₄′, which are 5-dimensional vectors.

Both common parameters and individual parameters are examples of partial parameters.

The learning parameter decomposition portion 188 generates partial parameters (z\hat{ }_{com}, z\hat{ }₁′), (z\hat{ }_{com}, z\hat{ }₂′), (z\hat{ }_{com}, z\hat{ }₃′), and (z\hat{ }_{com}, z\hat{ }₄′), which are four 25-dimensional vectors concatenated with the common parameter z\hat{ }_{com} and the individual parameters z\hat{ }′, z\hat{ }₂′, z\hat{ }₃′, and z\hat{ }₄′. The optimization calculation portion 186 performs optimization calculations on each of these four partial parameters as learning objects.

In this way, in a case where the optimization calculation portion 186 performs the optimization calculation multiple times, by providing a common parameter for each optimization calculation, it is possible to transmit information between each optimization calculation. This is expected to improve the learning accuracy (the accuracy of the parameter values obtained by the optimization calculation) compared to in a case where the optimization calculation portion 186 performs optimization calculations for each partial parameter that is independent of each other.

However, the number of dimensions of the learning parameter z is not limited to a specific number of dimensions. Furthermore, the number of dimensions of the common parameters obtained by the learning parameter decomposition portion 188 dividing the learning parameter z is not limited to a specific number of dimensions. Furthermore, the number and number of dimensions of the individual parameters obtained by dividing the learning parameter z by the learning parameter decomposition portion 188 are not limited to a specific number and number of dimensions. Furthermore, the common parameter z\hat{ }_{com} and partial parameters z\hat{ }ᵢ′ obtained by the learning parameter decomposition portion 188 dividing the learning parameter z may be the same as any of the above-mentioned basis vector z\hat{ }ᵢ, or may be different.

Furthermore, the method by which the learning parameter decomposition portion 188 selects which elements of the learning parameters z to combine into the common parameters and the individual parameters is not limited to a specific selection method. For example, the learning parameter decomposition portion 188 may combine elements of the learning parameters z that are not adjacent to each other to generate the common parameter z\hat{ }_{com}. In addition, the learning parameter decomposition portion 188 may generate individual parameters z\hat{ }ᵢ′ by combining elements of the learning parameters z that are not adjacent to each other.

The process in which the learning parameter decomposition portion 188 generates partial parameters with fewer dimensions from the learning parameters z as parameters to be learned (parameters whose values are to be updated in optimization calculations) is also referred to as dimensionality reduction processing.

As described above, the learning parameter decomposition portion 188 may divide the learning parameter z into a plurality of partial parameters to be used as parameters to be learned. Alternatively, as described above, the learning parameter decomposition portion 188 may generate partial parameters by combining common parameters and individual parameters, and use these as parameters to be learned.

Alternatively, the partial parameters used in common in a plurality of optimization calculations do not need to be fixed to a specific partial parameter.

For example, in the example of FIG. 5, the learning parameter decomposition portion 188 may generate partial parameters (z\hat{ }₁, z\hat{ }₂), (z\hat{ }₂, z\hat{ }₃), (z\hat{ }₃, z\hat{ }₄), and (z\hat{ }₄, z\hat{ }₁) by concatenating two partial parameters. Then, the optimization calculation portion 186 may perform optimization calculations for each of these partial parameters.

The learning parameter decomposition portion 188 transmits the partial parameters generated as the parameters to be learned to the optimization calculation portion 186.

In a case where the prompt acquisition portion 183 acquires the parameter values updated by the optimization calculation portion 186, it generates learning parameters by performing the reverse process of the process performed by the learning parameter decomposition portion 188. The prompt acquisition portion 183 then performs the reverse process of the process performed by the learning prompt decomposition portion 187 to generate a learning prompt. Then, as described above, the prompt acquisition portion 183 generates a prompt by combining the class name, the learning prompt, and the fixed prompt.

In the reverse process of the process performed by the learning parameter decomposition portion 188, the prompt acquisition portion 183 extracts partial parameters from the parameter values updated by the optimization calculation portion 186, and concatenates the extracted partial parameters in the order in which they were arranged in the original learning parameters to generate learning parameters.

For example, in a case where the learning parameter decomposition portion 188 sets each of the partial parameters obtained by dividing the learning parameter as a parameter to be learned, the prompt acquisition portion 183 generates a learning parameter by concatenating the parameter values updated by the optimization calculation portion 186 in the order of the original learning parameters.

Alternatively, in a case where the learning parameter decomposition portion 188 generates partial parameters to be learned by concatenating the common parameter and each of the individual parameters, the prompt acquisition portion 183 extracts the common parameter and each of the individual parameters from the parameter values updated by the optimization calculation portion 186. Then, the prompt acquisition portion 183 generates learning parameters by concatenating the extracted common parameter and individual parameters in the order in which they are arranged in the original learning parameters.

In the reverse process of the process performed by the learning prompt decomposition portion 187, the prompt acquisition portion 183 calculates elements pᵢ of the learning prompt based on the above Equation (1). That is, the prompt acquisition portion 183 divides the learning vector z into basis vectors z\hat{ }ᵢ, and for each basis vector z\hat{ }ᵢ, calculates an element pᵢ of the learning prompt by adding the average prompt p₀ to the product of the projection matrix A and the defined vector z\hat{ }ᵢ. Then, the prompt acquisition portion 183 generates a learning prompt p by concatenating the elements pᵢ of the learning prompt in the order in which they are arranged in the learning vector z of the original basis vector z\hat{ }ᵢ.

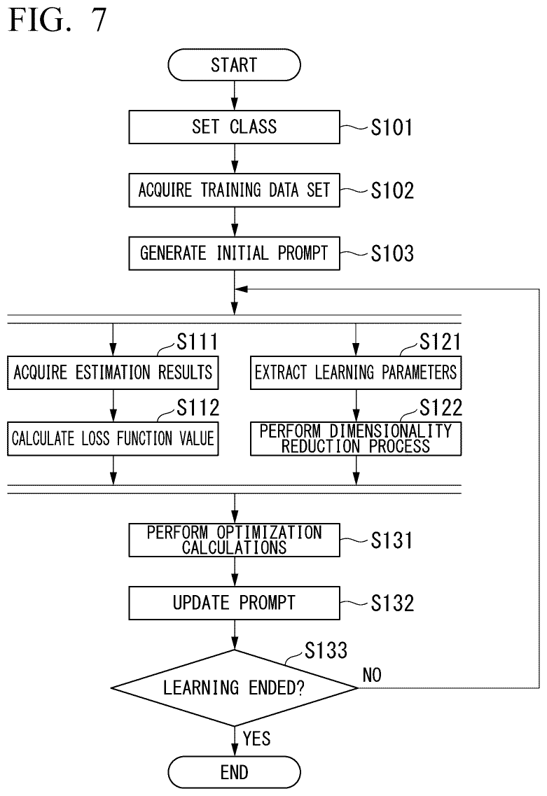

FIG. 7 is a diagram showing an example of a processing procedure in which learning device 100 learns a prompt. In the process of FIG. 7, the class setting portion 181 obtains a class name for image classification (Step S101). As described above, the acquisition of a class name by the class setting portion 181 can be considered as setting a class as a candidate for identifying an image.

Next, the training data acquisition portion 182 acquires a training data set to be used for learning the prompt (Step S102).

Next, the prompt acquisition portion 183 acquires an initial prompt (initial value of the prompt) (Step S103). As described above, the prompt acquisition portion 183 may use a learning prompt generated from random learning parameter values as the initial value of the learning prompt. The prompt acquisition portion 183 may then combine the class name, the initial value of the learning prompt, and the fixed prompt to generate the initial value of the prompt.

After Step S103, the foundation model application portion 184 inputs the image data and the prompt to the foundation model system 900 and obtains the estimation results by the foundation model system 900 (Step S111). For example, the foundation model application portion 184 obtains a likelihood vector indicating the likelihood that an image will be identified for each class as an estimation result by the foundation model system 900.

Next, the loss function calculation portion 185 calculates a loss function value for learning the prompt based on the estimation result acquired by the foundation model application portion 184 (Step S112).

After Step S103, the learning prompt decomposition portion 187 decomposes the elements of the learning prompt to extract the learning parameters (Step S121).

Next, the learning parameter decomposition portion 188 performs a dimensionality reduction process on the learning parameters extracted by the learning prompt decomposition portion 187 to generate partial parameters of the learning target (Step S122).

After steps S112 and S122, the optimization calculation portion 186 performs optimization calculations to update the parameter values (Step S131).

Next, the prompt acquisition portion 183 updates the prompt based on the parameter values updated by the optimization calculation portion 186 (Step S132).

Next, the processing portion 180 determines whether or not a condition for ending the learning is met (Step S133). The condition for ending the learning here is not limited to a specific condition. For example, the condition for ending the learning here may be a condition that the optimization calculation portion 186 has repeatedly executed the optimization process in Step S131 a predetermined number of times or more. Alternatively, the condition for ending the learning here may be that the value of the loss function becomes smaller than a predetermined threshold (a good evaluation is obtained). Alternatively, the condition for ending the learning here may be that the accuracy of classification by the foundation model system 900 becomes higher than or equal to a predetermined threshold value.

If the processing portion 180 determines that the learning end condition is not satisfied (Step S133: NO), the process returns to steps S111 and S121.

On the other hand, if the processing portion 180 determines that the learning end condition is met (Step S133: YES), the learning device 100 ends the processing in FIG. 7.

In a case where the estimation system 1 is in operation after the learning of the prompt is completed, the learning device 100 may input image data and a prompt obtained by removing the class name from the data structure of the prompt shown in FIG. 4 to the foundation model system 900.

As described above, the learning parameter decomposition portion 188 divides multiple elements of the parameters of the second data input to the foundation model system 900, which receives input of the first data and the second data and estimates the correlation between the first data and the second data, into multiple partial parameter elements. The prompt corresponds to an example of the second data.

The optimization calculation portion 186 learns the values of the elements contained in the partial parameter or combination of partial parameters based on the estimation results obtained by inputting the first data and the second data into the foundation model system 900, for each partial parameter or combination of partial parameters.

According to the learning device 100, individual optimization calculations can be performed on partial parameters or combinations of partial parameters, which are parameters with a smaller number of dimensions than the learning parameters, as the target of value updating. In this respect, according to the learning device 100, even if a differentiable function showing the relationship between the input data to the foundation model system 900 and the output data of the foundation model system 900 cannot be obtained, it is possible to improve the efficiency of learning the input data to the foundation model system 900.

The first data is image data.

According to the learning device 100, in a case where performing image recognition using the foundation model system 900, even in a case where a differentiable function showing the relationship between the input data to the foundation model system 900 and the output data of the foundation model system 900 cannot be obtained, the learning of the input data to the foundation model system 900 can be made more efficient.

Furthermore, the learning parameter decomposition portion 188 separates the multiple elements of the parameters of the second data into a common parameter element and multiple individual parameter elements.

For each combination of the common parameter and one individual parameter, the optimization calculation portion 186 learns the values of the elements included in the combination of the common parameter and the individual parameter based on the estimation results obtained by inputting the first data and the second data into the foundation model system 900.

According to the learning device 100, in a case where performing optimization calculations multiple times, by providing common parameters for each optimization calculation, it is possible to transmit information between each optimization calculation. In this respect, the learning device 100 is expected to improve the learning accuracy (the accuracy of the parameter values obtained by the optimization calculation) compared to a case in which optimization calculations are performed for each partial parameter that is independent of each other.

In addition, the learning prompt decomposition portion 187 converts partial data into parameters of the second data so that the partial data represented by a real vector of the second data is the sum of the product of a projection matrix, which is a matrix of real constants obtained by randomly sampling elements from a normal distribution having a word embedding variance, which is the vocabulary that is assumed to be received as the second data by the base model system 900, and the vector representation of the parameters of the second data, and the word embedding average value of the vocabulary assumed to be the vocabulary of the second data received by the base model system 900.

The prompt acquisition portion 183 calculates partial data of the second data by summing the product of the projection matrix and the vector representation of the parameters of the second data obtained from the learning results by the learning means, and the word embedding average value of the vocabulary assumed to be the vocabulary of the second data received by the foundation model system 900.

According to the learning device 100, the parameter values of the second data can be set to values that are correlated with the coordinate values of the vocabulary used in the second data projected onto a real vector space. In this respect, learning device 100 is expected to enable prompt learning with relatively high accuracy and a low amount of calculation.

In addition, the learning parameter decomposition portion 188 separates multiple elements of the parameters of the input data input to the foundation model system 900, which is a learned model, into multiple partial parameter elements.

The optimization calculation portion 186 learns the values of the elements contained in the partial parameters or combinations of partial parameters based on the model output values obtained by inputting input data into the foundation model system 900, for each partial parameter or combination of partial parameters.

According to the learning device 100, partial parameters or combinations of partial parameters, which are parameters with a smaller number of dimensions than the entire parameters of the input data to the foundation model system 900, can be subjected to value updating to perform individual optimization calculations. In this respect, according to the learning device 100, even if a differentiable function showing the relationship between the input data to the foundation model system 900 and the output data of the foundation model system 900 cannot be obtained, it is possible to improve the efficiency of learning the input data to the foundation model system 900.

### Second Example Embodiment

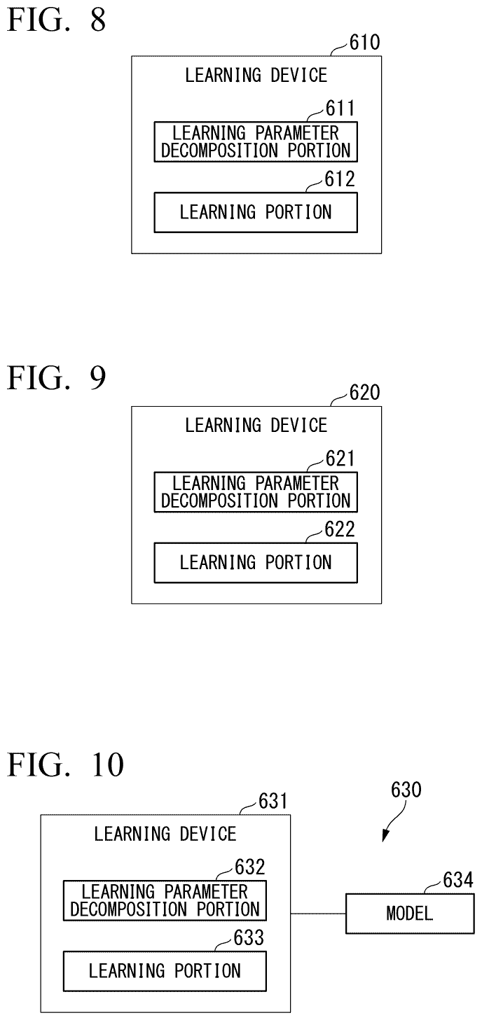

FIG. 8 is a diagram illustrating another example of a configuration of a learning device according to at least one example embodiment. In the configuration shown in FIG. 8, a learning device 610 includes a learning parameter decomposition portion 611 and a learning portion 612.

With this configuration, the learning parameter decomposition portion 611 receives input of the first data and the second data and divides the multiple elements of the parameters of the second data that are input to a model that estimates the correlation between the first data and the second data into multiple partial parameter elements.

The learning portion 612 learns the values of elements included in the partial parameters or combinations of partial parameters based on the estimation results obtained by inputting the first data and the second data into the model, for each partial parameter or combination of partial parameters.

The learning parameter decomposition portion 611 corresponds to an example of a learning parameter decomposition means. The learning portion 612 corresponds to an example of a learning means.

According to the learning device 610, it is possible to perform individual learning by targeting partial parameters or combinations of partial parameters, which are parameters with smaller dimensionality than the entire second data parameter, for value updating. In this respect, the learning device 610 can improve the efficiency of learning input data to a model even in a case where a differentiable function showing the relationship between input data to the model and output data of the model cannot be obtained.

The learning parameter decomposition portion 611 can be realized, for example, by using the functions of the learning parameter decomposition portion 188 in FIG. 2. The learning portion 612 can be realized, for example, by using the functions of the optimization calculation portion 186 in FIG. 2.

### Third Example Embodiment

FIG. 9 is a diagram illustrating yet another example of a configuration of a learning device according to at least one example embodiment. In the configuration shown in FIG. 9, a learning device 620 includes a learning parameter decomposition portion 621 and a learning portion 622.

With this configuration, the learning parameter decomposition portion 621 separates multiple elements of the parameters of the input data to be input to the learned model into multiple partial parameter elements.

The learning portion 622 learns, for each partial parameter or combination of partial parameters, the values of the elements included in the partial parameter or combination of partial parameters, based on the model output value obtained by inputting input data into the model.

The learning parameter decomposition portion 621 corresponds to an example of a learning parameter decomposition means. The learning portion 622 corresponds to an example of a learning means.

According to the learning device 620, it is possible to perform individual learning by targeting partial parameters or combinations of partial parameters, which are parameters with smaller dimensionality than the entire parameters of the input data to the model, for value updating. In this respect, the learning device 620 can improve the efficiency of learning input data to a model even in a case where a differentiable function showing the relationship between input data to the model and output data of the model cannot be obtained.

### Fourth Example Embodiment

FIG. 10 is a diagram illustrating another example configuration of an estimation system according to at least one example embodiment. In the configuration shown in FIG. 10, the estimation system 630 includes a learning device 631 and a model 634. The learning device 631 includes a learning parameter decomposition portion 632 and a learning portion 633.

In this configuration, the model 634 receives input of the first data and the second data as input and estimates the correlation between the first data and the second data.

The learning parameter decomposition portion 632 separates the multiple elements of the parameters of the second data into multiple partial parameter elements.

The learning portion 633 learns the values of elements included in the partial parameters or combinations of partial parameters based on the estimation results obtained by inputting the first data and the second data into the model 634, for each partial parameter or combination of partial parameters.

The learning parameter decomposition portion 632 corresponds to an example of a learning parameter decomposition means. The learning portion 633 corresponds to an example of a learning means.

According to the estimation system 630, partial parameters or combinations of partial parameters, which are parameters having a smaller number of dimensions than the entire parameters of the second data, can be individually learned by updating their values. In this respect, the estimation system 630 can improve the efficiency of learning the input data to the model even in a case where a differentiable function showing the relationship between the input data to the model and the output data of the model cannot be obtained.

The learning parameter decomposition portion 632 can be realized, for example, by using the functions of the learning parameter decomposition portion 188 in FIG. 2. The learning portion 633 can be realized, for example, by using the functions of the optimization calculation portion 186 in FIG. 2.

### Fifth Example Embodiment

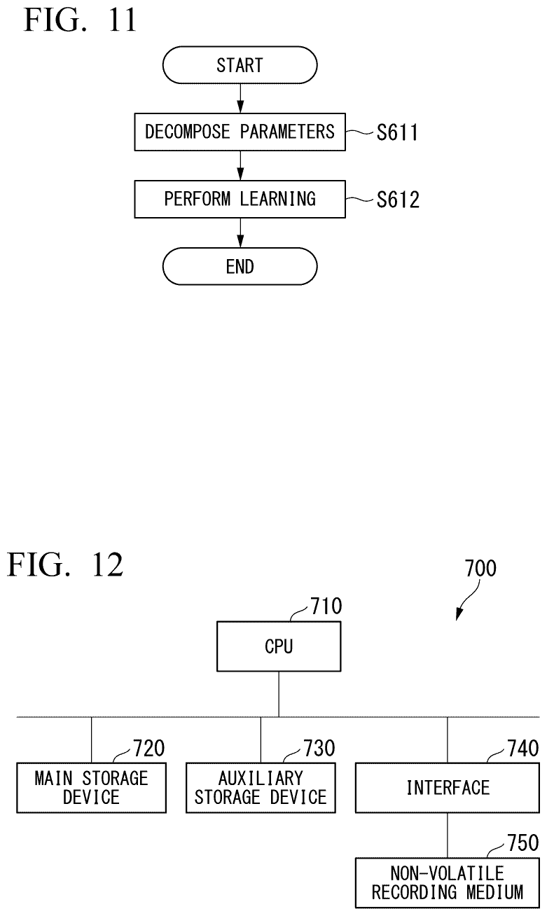

FIG. 11 is a diagram illustrating an example of a processing procedure in a learning method according to at least one example embodiment. The learning method shown in FIG. 11 includes decomposing parameters (Step S611) and performing learning (Step S612).

In decomposing the parameters (Step S611), a computer receives input of the first data and the second data and divides multiple elements of the parameters of the second data that are input to a model that estimates the correlation between the first data and the second data into multiple partial parameter elements.

In learning (Step S612), the computer learns the values of elements included in the partial parameters or combinations of partial parameters based on the estimation results obtained by inputting the first data and the second data into the model for each partial parameter or combination of partial parameters.

According to the learning method shown in FIG. 11, partial parameters or combinations of partial parameters, which are parameters having a smaller number of dimensions than the entire parameters of the second data, can be individually learned by updating their values. In this respect, the learning method shown in FIG. 11 can improve the efficiency of learning input data to a model even in a case where a differentiable function showing the relationship between input data to the model and output data of the model cannot be obtained.

FIG. 12 is a diagram illustrating an example configuration of a computer in accordance with at least one example embodiment. In the configuration shown in FIG. 12, a computer 700 includes a CPU 710, a main storage device 720, an auxiliary storage device 730, an interface 740, and a non-volatile recording medium 750.

Any one or more of the above-mentioned learning device 100, foundation model system 900, learning device 620, learning device 631, and model 634, or a part thereof, may be implemented in the computer 700. In this case, the operations of the above-mentioned processing units are stored in the auxiliary storage device 730 in the form of a program. The CPU 710 reads the program from the auxiliary storage device 730, loads it into the main storage device 720, and executes the above-mentioned processing in accordance with the program. Furthermore, the CPU 710 allocates storage areas in the main storage device 720 corresponding to the above-mentioned respective storage portions in accordance with the program. Communication between each device and other devices is performed by the interface 740 having a communication function and performing communication under the control of the CPU 710. The interface 740 also has a port for the non-volatile recording medium 750, and reads information from the non-volatile recording medium 750 and writes information to the non-volatile recording medium 750.

In a case where the learning device 100 is implemented in the computer 700, the operations of the processing portion 180 and each of its units are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area for the storage portion 170 in the main storage device 720 in accordance with the program. Communication with other devices by the communication portion 110 is performed by an interface 740 having a communication function and operating under the control of the CPU 710. The display of images by the display portion 120 is executed by having the interface 740 equipped with a display device and displaying various images under the control of the CPU 710. The operation input portion 130 receives user operations by having the interface 740 equipped with an input device and receiving the user operations under the control of the CPU 710.

In a case where the foundation model system 900 is implemented in the computer 700, its operations are stored in the auxiliary storage device 730 in the form of a program. The CPU 710 reads the program from the auxiliary storage device 730, loads it into the main storage device 720, and executes the above-mentioned processing in accordance with the program.

In addition, the CPU 710 allocates a storage area in the main storage device 720 for the foundation model system 900 to perform processing in accordance with the program. Communication between the foundation model system 900 and other devices is performed by the interface 740 having a communication function and operating under the control of the CPU 710. Interaction between the foundation model system 900 and a user is carried out by the interface 740 having an input device and an output device, presenting information to the user via the output device under the control of the CPU 710, and receiving user operations via the input device.

In a case where the learning device 610 is implemented in the computer 700, the operations of the learning parameter decomposition portion 611 and the learning portion 612 are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the learning device 610 to perform processing in accordance with the program. Communication between the learning device 610 and other devices is performed by the interface 740 having a communication function and operating under the control of the CPU 710. Interaction between the learning device 610 and a user is carried out by the interface 740 having an input device and an output device, presenting information to the user via the output device under the control of the CPU 710, and receiving user operations via the input device.

In a case where the learning device 620 is implemented in the computer 700, the operations of the learning parameter decomposition portion 621 and the learning portion 622 are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the learning device 620 to perform processing in accordance with the program. Communication between the learning device 620 and other devices is performed by the interface 740 having a communication function and operating under the control of the CPU 710. Interaction between the learning device 620 and a user is carried out by the interface 740 having an input device and an output device, presenting information to the user via the output device under the control of the CPU 710, and receiving user operations via the input device.

In a case where the learning device 631 is implemented in the computer 700, the operations of the learning parameter decomposition portion 632 and the learning portion 633 are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the learning device 631 to perform processing in accordance with the program. Communication between the learning device 631 and other devices is performed by the interface 740 having a communication function and operating under the control of the CPU 710. Interaction between the learning device 631 and a user is carried out by the interface 740 having an input device and an output device, presenting information to the user via the output device under the control of the CPU 710, and receiving user operations via the input device.

In a case where the model 634 is implemented in the computer 700, its operations are stored in the auxiliary storage device 730 in the form of a program. The CPU 710 reads the program from the auxiliary storage device 730, loads it into the main storage device 720, and executes the above-mentioned processing in accordance with the program.

Furthermore, the CPU 710 reserves a storage area in the main storage device 720 for the model 634 to perform processing in accordance with the program. Communication between the model 634 and other devices is performed by the interface 740 having a communication function and operating under the control of the CPU 710. Interaction between the model 634 and a user is carried out by the interface 740 having an input device and an output device, presenting information to the user via the output device under the control of the CPU 710, and receiving user operations via the input device.

Any one or more of the above-mentioned programs may be recorded in the non-volatile recording medium 750. In this case, the interface 740 may read the program from the non-volatile recording medium 750. The CPU 710 may then directly execute the program read by the interface 740, or may temporarily store the program in the main storage device 720 or the auxiliary storage device 730 and then execute it.

In addition, a program for executing all or part of the processing performed by the learning device 100, the foundation model system 900, the learning device 620, the learning device 631, and the model 634 may be recorded on a computer-readable recording medium, and the program recorded on this recording medium may be read into a computer system and executed to perform the processing of each part. It should be noted that the term “computer system” herein includes an OS (Operating System) and hardware such as peripheral devices.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing some of the functions described above, and may further be capable of realizing the functions described above in combination with a program already recorded in the computer system.

According to one example aspect of the present disclosure, even in a case where a differentiable function showing the relationship between the input data to a model and the output data of the model cannot be obtained, it is possible to improve the efficiency of learning the input data to the model.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims. Furthermore, the above-described example embodiments may be combined with other example embodiments as appropriate.

Some or all of the above-described example embodiments can be described as follows, but is not limited to the following.

### (Supplementary Note 1)

A learning device comprising:
a learning parameter decomposition means that receives input of first data and second data and divides a plurality of elements of parameters of the second data, which are input to a model that estimates the correlation between the first data and the second data, into a plurality of partial parameter elements; and
a learning means that learns, for each of the partial parameters or each of the combinations of the partial parameters, a value of an element included in the partial parameter or each combination of the partial parameters based on an estimation result obtained by inputting the first data and the second data into the model.

### (Supplementary Note 2)

The learning device according to Supplementary Note 1,
wherein the first data is image data.

### (Supplementary Note 3)

The learning device according to Supplementary Note 1 or Supplementary Note 2,
wherein the learning parameter decomposition means divides the plurality of elements of the parameters of the second data into a common parameter element and a plurality of individual parameter elements; and
the learning means learns, for each combination of the common parameter and one individual parameter, values of elements included in the combination based on an estimation result obtained by inputting the first data and the second data into the model.

### (Supplementary Note 4)

The learning device according to any one of supplementary notes 1 to 3, further comprising:
a learning prompt decomposition means that converts partial data represented by a real vector of the second data into parameters of the second data so that the partial data is the sum of the product of a projection matrix, which is a matrix of real constants obtained by randomly sampling elements from a normal distribution having a word embedding variance of vocabulary assumed as the vocabulary of the second data received by the model, and a vector representation of the parameters of the second data, and the word embedding average value of the vocabulary; and
a second data acquisition means that calculates the partial data of the second data by summing the product of the projection matrix and the vector representation of the parameters of the second data obtained from the learning result by the learning means and an average word embedding value of the vocabulary.

### (Supplementary Note 5)

A learning device comprising:
a learning parameter decomposition means that divides a plurality of elements of parameters of input data to be input to a learned model into a plurality of partial parameter elements; and
a learning means that learns, for each of the partial parameters or each of the combinations of the partial parameters, a value of an element included in the partial parameter or combination of the partial parameters based on a model output value obtained by inputting the input data into the model.

### (Supplementary Note 6)

An estimation system comprising:
a model that receives input of first data and second data and estimates a correlation between the first data and the second data;
a learning parameter decomposition means that divides a plurality of elements of the parameters of the second data into a plurality of partial parameter elements; and
a learning means that learns, for each of the partial parameters or each of the combinations of the partial parameters, a value of an element included in the partial parameter or combination of the partial parameters based on an estimation result obtained by inputting the first data and the second data into the model.

### (Supplementary Note 7)

A learning method includes a computer:
receiving input of first data and second data and dividing a plurality of elements of parameters of the second data, which are input to a model that estimates the correlation between the first data and the second data, into a plurality of partial parameter elements; and
learning, for each of the partial parameters or each combination of the partial parameters, a value of an element included in the partial parameter or combination of the partial parameters based on an estimation result obtained by inputting the first data and the second data into the model.

### (Supplementary Note 8)

A program causing a computer to execute
receiving input of first data and second data and dividing a plurality of elements of parameters of the second data, which are input to a model that estimates the correlation between the first data and the second data, into a plurality of partial parameter elements; and
learning, for each of the partial parameters or each combination of the partial parameters, a value of an element included in the partial parameter or combination of the partial parameters based on an estimation result obtained by inputting the first data and the second data into the model.

Supplementary notes corresponding to supplementary notes 2 to 4, which are subordinate to Supplementary Note 1, may also be provided for each of supplementary notes 6 to 8.

What is claimed is:

1. A learning device comprising:
at least one memory configured to store instructions; and
at least one processor configured to execute the instructions to:
receive input of first data and second data and divide a plurality of elements of parameters of the second data, which are input to a model that estimates a correlation between the first data and the second data, into a plurality of partial parameter elements; and
perform training, for each of the partial parameters or each of combinations of the partial parameters, by using a value of an element included in the partial parameter or the combination of the partial parameters based on an estimation result obtained by inputting the first data and the second data into the model.

2. The learning device according to claim 1, wherein the first data is image data.

3. The learning device according to claim 1, wherein the at least one processor is configured to execute the instructions to:
divide the plurality of elements of the parameters of the second data into a common parameter element and a plurality of individual parameter elements; and
perform training, for each combination of the common parameter and one individual parameter, by using values of elements included in the combination based on the estimation result obtained by inputting the first data and the second data into the model.

4. The learning device according to claim 1, wherein the at least one processor is configured to execute the instructions to:
convert partial data represented by a real vector of the second data into parameters of the second data so that the partial data is the sum of the product of a projection matrix, which is a matrix of real constants obtained by randomly sampling elements from a normal distribution having a word embedding variance of vocabulary assumed as the vocabulary of the second data received by the model, and a vector representation of the parameters of the second data, and the word embedding average value of the vocabulary; and
calculate the partial data of the second data by summing the product of the projection matrix and the vector representation of the parameters of the second data obtained from the learning result and an average word embedding value of the vocabulary.

5. A learning device comprising:
at least one memory configured to store instructions; and
at least one processor configured to execute the instructions to:
divide a plurality of elements of parameters of input data to be input to a learned model into a plurality of partial parameter elements; and
perform training, for each of the partial parameters or each of combinations of the partial parameters, by using a value of an element included in the partial parameter or the combination of the partial parameters based on a model output value obtained by inputting the input data into the model.

6. A learning method executed by a computer, the method comprising:
receiving input of first data and second data and dividing a plurality of elements of parameters of the second data, which are input to a model that estimates a correlation between the first data and the second data, into a plurality of partial parameter elements; and
performing training, for each of the partial parameters or each combination of the partial parameters, by using a value of an element included in the partial parameter or the combination of the partial parameters based on an estimation result obtained by inputting the first data and the second data into the model.
